(19) United States
(12) Patent Application Publication
(10) Pub. No.: US 2016/0157685 A1
(43) Pub. Date: Jun. 9, 2016

(54) LUMINOUS ROTATING SHAFT OF TOILET SEAT COVER

(71) Applicants: Xingyi YU, Xiamen (CN); Dong PENG, Xiamen (CN)

(72) Inventors: Shaojie SHI, Xiamen (CN); Zhenyu DAI, Xiamen (CN)

(73) Assignees: Dong PENG, Xiamen (CN); Xingyi YU, Xiamen (CN)

(21) Appl. No.: 14/816,666

(22) Filed: Aug. 3, 2015

(30) Foreign Application Priority Data
Dec. 8, 2014 (CN) 201410743565.9

(51) Int. Cl. A47K 13/12; F21V 23/00; F21V 23/04; F21V 3/00; F21V 33/00; F21S 9/02

(52) U.S. Cl. CPC A47K 13/12; F21V 33/004; F21S 9/02; F21V 23/0464; F21V 23/0471; F21V 3/00; F21V 23/002

(57) ABSTRACT

A luminous rotating shaft of toilet seat cover includes a shaft sleeve with two ends that the toilet seat cover is rotatably pivot joined to, a luminous unit with a front light source, a rear light source and a battery module. The luminous unit is detachably assembled in the shaft sleeve. The shaft sleeve has a front window corresponding to the front light source. The front light source provides light to the toilet through the front window. The shaft sleeve has a rear window corresponding to the rear light source. The rear light source provides light to the toilet water tank or the wall through the rear window. The luminous unit includes two photosensors that collect light at the front side and at the rear side of the shaft sleeve. The front light source and the rear light source startup to provide light if the photosensors both collect no light.

### FIELD OF THE UTILITY MODEL

The utility model relates to a luminous rotating shaft of toilet seat cover, especially to a luminous rotating shaft of toilet seat cover with luminous function.

### BACKGROUND OF THE UTILITY MODEL

When people get up to go to the toilet in the nighttime, they sometimes light up the lighting, but the strong light may irritate eyes and make them uncomfortable, even making people be wide awake, thus influencing the sleeping. If they don't light up the lighting, they can not find the toilet quickly and accurately. Therefore, someone designed a toilet seat cover with luminous function. However, this kind of luminous toilet seat cover performs its luminous function only if it is lighted up, once the toilet seat cover is closed, it blocks the light source, losing its luminous function.

### SUMMARY OF THE UTILITY MODEL

The utility model provides a luminous rotating shaft of toilet seat cover with luminous function that overcomes the disadvantages of the existing technology, the technical proposal of the utility model is that:

A luminous rotating shaft of toilet seat cover, comprising:

a shaft sleeve with two ends that the toilet seat cover is rotatably pivot joint to;

a luminous unit comprising a front light source, a rear light source and a battery module to supply power to the front light source and the rear light source;

the luminous unit is detachably assembled in the shaft sleeve, the shaft sleeve is disposed with a front window corresponding to the front light source, the front light source provides light to the toilet through the front window, the shaft sleeve is disposed with a rear window corresponding to the rear light source, the rear light source provides light to the toilet water tank or the wall through the rear window, the luminous unit further comprises two photosensors that are used to collect the light of the front side and rear side of the shaft sleeve, the front light source and the rear light source startup to provide light if two photosensors collect no light at the same time at the same time.

In another preferred embodiment, the luminous unit further comprises a sound collecting component, two photosensors are arranged respectively corresponding to the front window and the rear window; the sound collecting component startups if two photosensors collect no light at the same time; the front light source and the rear light source startup to provide light if the sound collecting component receives sound signal.

In another preferred embodiment, the luminous unit further comprises a front baseboard and a rear baseboard, the front light source, the sound collecting component and one of the photosensors are disposed in the front baseboard, the rear light source and the other photosensor are disposed in the rear baseboard.

In another preferred embodiment, the battery module comprises battery and battery compartment, the battery is placed in the battery compartment, the front baseboard and the rear baseboard are respectively connected to the front side and the rear side of the battery compartment.

In another preferred embodiment, the luminous unit further comprises a cover and a transparent window, the cover is locked to the battery compartment, the cover is disposed with an opening, the transparent window covers the opening.

In another preferred embodiment, it comprises a flexible elastic lock rod connected to the luminous unit and locked to the shaft sleeve.

In another preferred embodiment, the elastic lock roc comprising an elastic wire and two pins respectively connected to two ends of the elastic wire.

A luminous rotating shaft of toilet seat cover, comprising a shaft sleeve with two ends that the toilet seat cover is rotatably pivot joint to, wherein further comprising a front light source, a rear light source and two photosensors, the two photosensors are used to collect the light at the front side and rear side of the shaft sleeve, the front light source and the rear light source startup to provide light if two photosensors collect no light at the same time, the front light source provides light to the toilet, the rear light source provides light to the toilet water tank or the wall.

In another preferred embodiment, it further comprises a sound collecting component, the sound collecting component startups if two photosensors collect no light at the same time; the front light source and the rear light source startup to provide light if the sound collecting component receives sound signal.

In another preferred embodiment, the sound collecting component is disposed in the shaft sleeve.

In another preferred embodiment, the shaft sleeve is disposed with a front window corresponding to the front light source, the front light source provides light to the toilet through the front window, the shaft sleeve is disposed with a rear window corresponding to the rear light source, the rear light source provides light to the toilet water tank or wall through the rear window.

In another preferred embodiment, it further comprises a front baseboard and a rear baseboard, the front light source, the sound collecting component and one of the photosensors are disposed in the front baseboard, the rear light source and the other photosensor are disposed in the rear baseboard.

A luminous rotating shaft of toilet seat cover, comprising a shaft sleeve with two ends that the toilet seat cover is rotatably pivot joint to, wherein further comprising a luminous unit disposed with a front light source, a rear light source, a battery module, a front baseboard, a rear baseboard, the front light source is disposed in the front baseboard, the rear light source is disposed in the rear baseboard, the battery module provides power to the front light source and the rear light source, the luminous unit is detachably assembled in the shaft sleeve, the front light source provides light the toilet, the rear light source provides light to the toilet water tank or the wall.

In another preferred embodiment, the shaft sleeve is disposed with two fixation holes, two support shafts on the toilet are disposed to respectively insert to the two fixation holes to secure the shaft sleeve to the toilet.

In another preferred embodiment, the luminous unit further comprising at least one photosensor, the front source and the rear source startup to provide light if the photosensor collects no light.

In another preferred embodiment, the luminous unit further comprises a sound collecting component and at least one photosensor, the sound collecting component startups if the photosensor collects no light, the front light source and the rear light source startup to provide light if the sound collecting component receives sound signal.

In another preferred embodiment, the luminous unit further comprises a sound collecting component and two photosensors, two photosensors are respectively used to collect the light at the front side and the rear side of the shaft sleeve, the sound collecting component startups if two photosensors collect no light at the same time; the front light source and the rear light source startup to provide light if the sound collecting component receives sound signal.

In another preferred embodiment, the front light source, the sound collecting component and one of the photosensors are disposed in the front baseboard, the rear light source and the other photosensor are disposed in the rear baseboard.

In another preferred embodiment, the battery module comprises battery and battery compartment, the battery is placed in the battery compartment, the front baseboard and the rear baseboard are disposed and connected to the front side and the rear side of the battery compartment.

Compared to the existing know technology, the technical proposal of the utility model has following advantages:

1. in nighttime, the toilet seat cover covers on the toilet, the rear light source lights up the toilet water tank or the wall through the rear window, so that people can get the toilet position quickly; when the toilet seat cover is lifted up, the front light source lights up the toilet through the front window, so that people can get the toilet position quickly. The luminous rotating shaft of the utility model is used with convenience.

2. two photosensors are used respectively to collect the light at the front side and the rear side of the shaft sleeve, the front light source and the rear light source startup to provide light only if two photosensors collect no light at the same time, when the toilet seat cover coves on the toilet plate, the latter can only block the light at the front side of the shaft sleeve, when the toilet seat cover is open, it can only block the light at the rear side of the shaft sleeve, so that the front light source and the rear light source provide light only in nighttime.

3. the sound collecting component startups if both photosensors collect no light at the same time, in daytime, whether the toilet seat cover is open or closed, at least one photosensor can collect light, so that the front light source and the rear light source do not work in daytime, thus saving power.

4. it comprises a flexible elastic lock rod, the elastic lock rod is connected to the luminous unit and is inserted to the shaft sleeve, operating the elastic lock rod can take the luminous unit away quickly, convenient for maintain and clean.

5. the luminous unit is detachably disposed in the shaft sleeve, when cleaning the toilet, the luminous unit can be taken of conveniently and quickly, keeping it from water, convenient for maintain and clean.

### BRIEF DESCRIPTION OF THE DRAWINGS

The utility model will be further described with the embodiments and the drawings.

FIG. 1 illustrates a schematic diagram of a luminous rotating shaft of toilet seat cover of the utility model connected to a toilet seat cover.

FIG. 2 illustrates a schematic diagram of the luminous rotating shaft of toilet seat cover of the utility model.

FIG. 3 illustrates an exploded and schematic diagram of the luminous unit of FIG. 2.

FIG. 4 illustrates a sectional diagram of the luminous unit of FIG. 2.

FIG. 5 illustrates a second sectional diagram of the luminous unit of FIG. 2.

FIG. 6 illustrates a schematic diagram of the luminous rotating shaft of toilet seat cover of the utility model lighting up the toilet water tank.

FIG. 7 illustrates a schematic diagram of the luminous rotating shaft of toilet seat cover of the utility model lighting up the toilet.

### DETAILED DESCRIPTION OF THE EMBODIMENTS

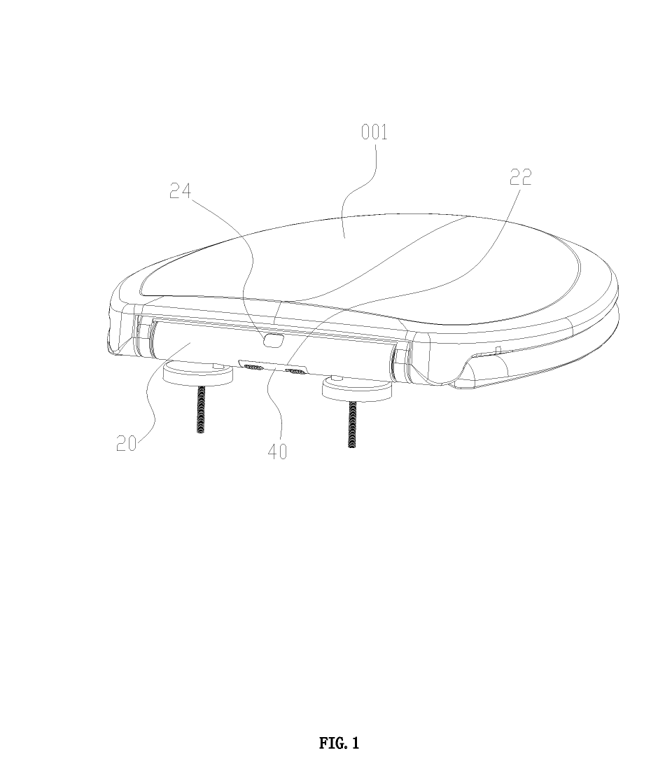

Referring to FIG. 1, a luminous rotating shaft of toilet seat cover in the utility model comprises a shaft sleeve 20, a luminous unit 40 and an elastic lock rod 60. The toilet seat cover 001 is rotatably pivot joint to the two ends of the shaft sleeve 20. The shaft sleeve 20 has a circular cross section. The shaft sleeve 20 is disposed with a front window 22 and a rear window 24.

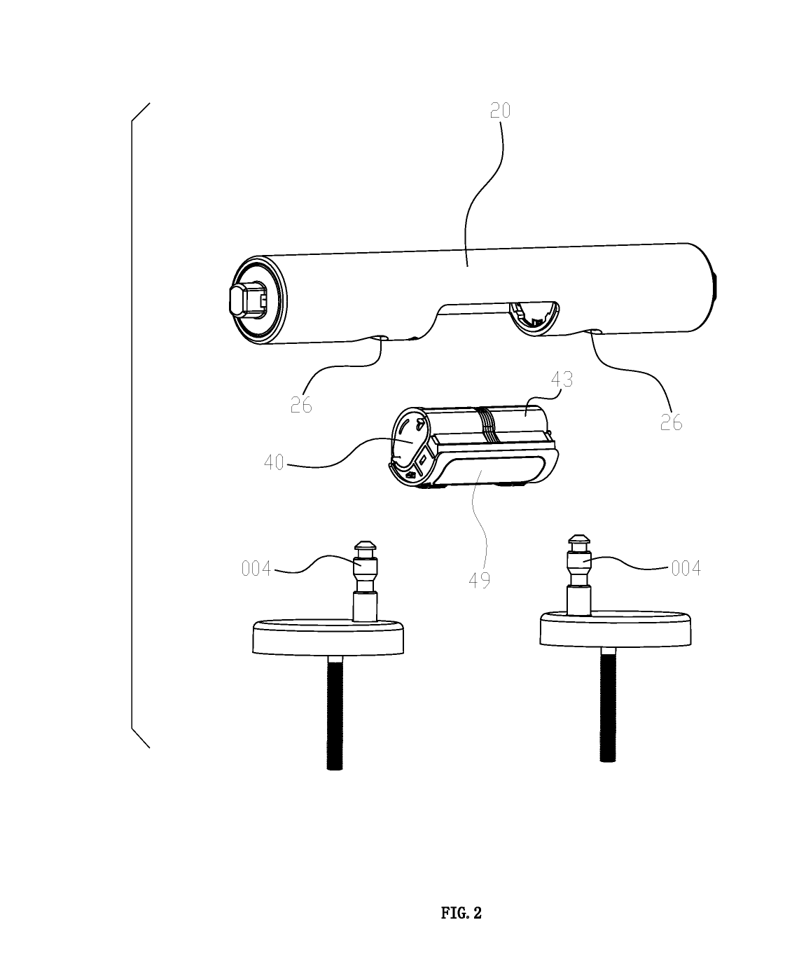

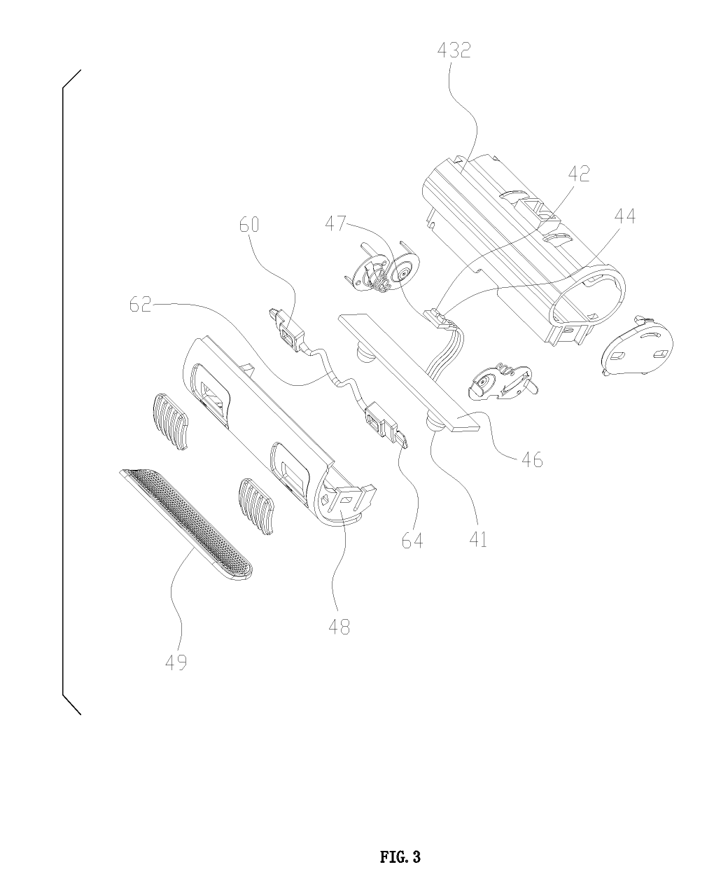

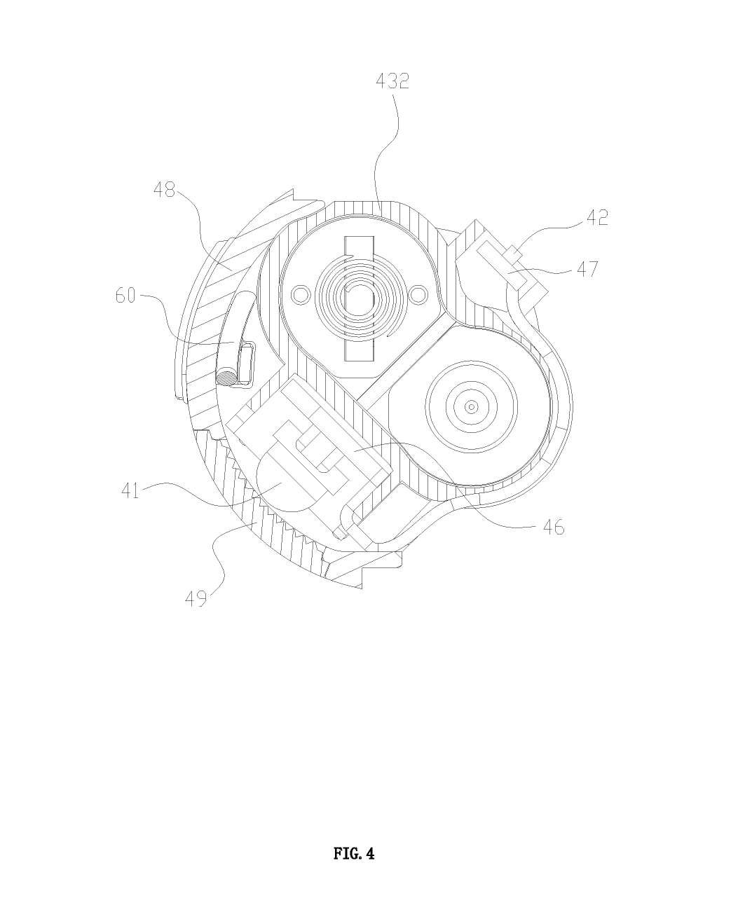

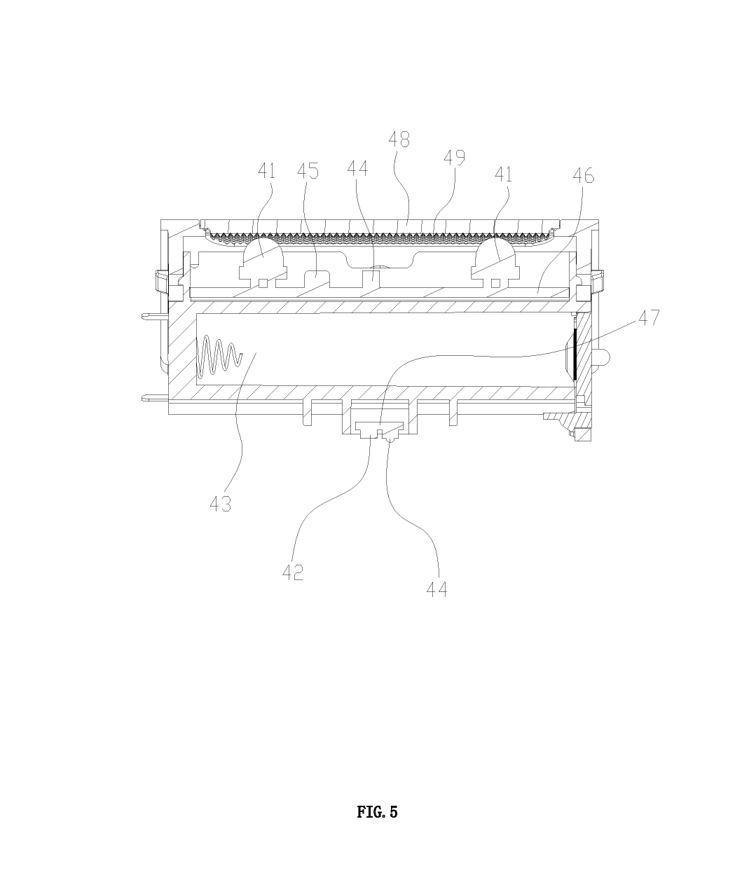

Referring to FIGS. 2-5, the luminous unit 40 comprises a front light source 41, a rear light source 42, a battery module 43, two photosensors 44, a sound collecting component 45, a front baseboard 46, a rear baseboard 47, a top cover 48 and a transparent window 49. the battery module 43 supplies power to the front light source 41, the rear light source 42 and the sound collecting component 45, the battery module 43 comprises battery and battery compartment 432, the battery is placed in the battery compartment 432.

The front light source 41, the sound collecting component 45 and one photosensor 44 are disposed in the front baseboard 46. The rear light source 42 and another photosensor 44 are disposed in the rear baseboard 47. The front baseboard 46 and the rear baseboard 47 are disposed on the outer side of the battery compartment 432, and are respectively connected at the front side and the rear side of the battery compartment 432.

The top cover 48 is locked to the battery compartment 432, the top cover 48 is disposed with an opening, the transparent window 49 covers the opening, the transparent window 49 is faced to the front baseboard 46.

The elastic lock rod 60 is used to connect the luminous unit 40 and the shaft sleeve 20 or to separate both. The elastic lock rod 60 comprises an elastic wire 62 and two pins 64 respectively connected to two ends of the elastic wire 62. The elastic lock rod 60 is disposed between the top cover 48 and the battery compartment 432.

The luminous unit 40 is detachably disposed in the shaft sleeve 20. The pins 64 are inserted to the shaft sleeve 20. The front window 22 aligns at the front baseboard 46, the rear window 24 aligns at the rear baseboard 47.

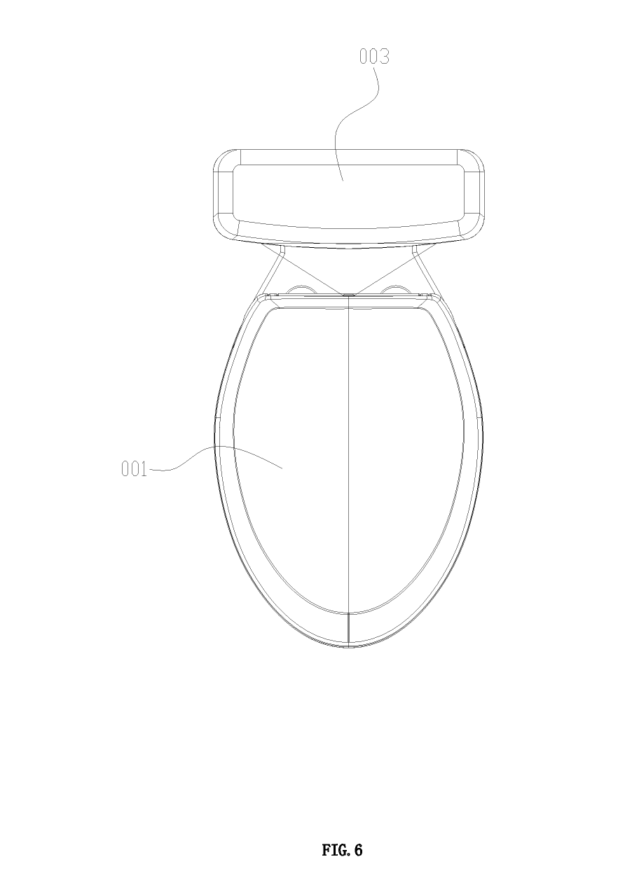

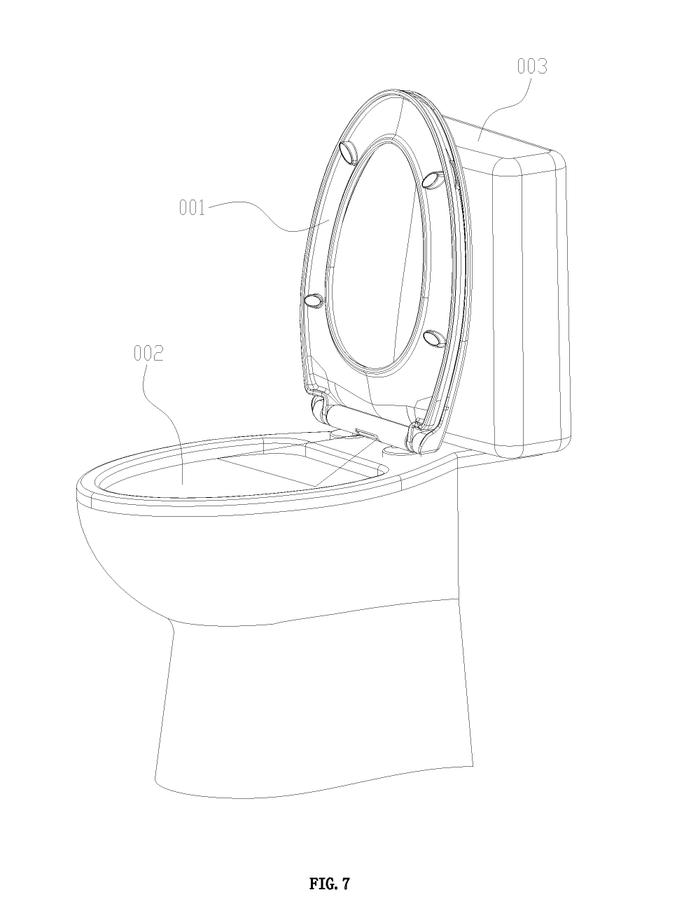

In daytime, even one photosensor 44 receives light, the sound collecting component 45 is in standby state, the front light source 41 and the rear light source 42 are not working. Only in nighttime, if the two photosensors 44 collect no light at the same time, the sound collecting component 45 startups, at this time, if the sound collecting component 45 receives sound signal, the front light source 41 and the rear light source 42 startup at the same time to provide light: the rear light source 42 lights up the toilet water tank 003 through the rear window 24 (as figured in FIG. 6), the front light source 41 lights up the toilet 002 through the front window 22 (as figured in FIG. 7). That is to say, the front light source 41, the rear light source 42, the battery module 43, the photosensors 44 and the sound collecting component 45 are series connected in a loop, only if two photosensors 44 get no light at the same time and the sound collecting component 45 gets no sound signal that the front light source 41, the rear light source 42, the battery module 43, the photosensors 44 and the sound collecting component 45 are in a closed circuit.

It can be understandable that the number of the front light source 41 and the rear light source 42 is not limited. The shaft sleeve 20 can also have other shapes of cross section but circular, it can be square shaped with top portion protruded. When the toilet water tank 003 is embedded into the wall, the rear light source 42 can be directly light on the wall. The positions of the front light source 41, the rear light source 42, the photosensors 44 and the sound collecting component 45 are not limited.

It is important to note that the luminous rotating shaft of the utility model is applied with the photosensors 44 to collect light around the toilet to determine daytime and nighttime so as to control the light source 41 and the rear light source 42, so that the luminous rotating shaft of the utility model can have following configuration:

The luminous rotating shaft comprises a shaft sleeve 20, and a front light source 41, a rear light source 41, two photosensors 44 disposed in the shaft sleeve 20, two photosensors 44 are respectively used to collect the light at the front side and the rear side of the shaft sleeve 20, the front light source 41 and the rear light source 41 startup to provide light if two photosensors 44 collect no light at the same time, the front light source 41 is used to light up the toilet, the rear light source 42 is used to light up the toilet water tank or the wall. Preferred, a sound collecting component 45 is configured, it startups if two photosensors 44 collect no light at the same time; the front light source 41 and the rear light source 42 startup to provide light if the sound collecting component 45 receives sound signal. Preferred, the sound collecting component 45 is disposed in the shaft sleeve 20. Preferred, the shaft sleeve 20 is disposed with a front window 22 corresponding to the front light source 41, the front light source 41 lights up the toilet through the front window 22, the shaft sleeve 20 is disposed with a rear window 24 corresponding to the rear light source 42, the rear light source 42 lights up the toilet water tank or the wall through the rear window 24. Preferred, a front baseboard 46 and a rear baseboard 47 are configured, the front light source 41, the sound collecting component 45 and one photosensor 44 are disposed in the front baseboard 46, the rear light source 42 and the other photosensor 44 are disposed in the rear baseboard 47.

In additive, the luminous rotating shaft of the utility model is disposed with the front light source 41 and the rear light source 42 to provide light, so that whether the toilet seat cover is open or closed, people can find the toilet quickly and accurately, the luminous rotating shaft of the utility model can have following configuration.

The luminous rotating shaft of the toilet seat cover comprises a shaft sleeve 20 and a luminous unit 40, the toilet seat cover 001 is rotatably pivot joint to the two ends of the shaft sleeve 20. the luminous unit 40 comprises a front light source 41, a rear light source 42, a battery module 43, a front baseboard 46, a rear baseboard 47, the front light source 41 is disposed in the front baseboard, the rear light source 42 is disposed in the rear baseboard 47, the battery module 43 provides power to the front light source 41 and the rear light source 42. The luminous unit 40 is detachably disposed in the shaft sleeve 20, the front light source 41 lights up the toilet, the rear light source 42 lights up the toilet water tank or the wall.

Preferred, please refer to FIG. 2 and FIG. 7, the shaft sleeve 20 is disposed with two fixation holes 26, the toilet 002 is disposed with two support shafts 004, which can be respectively inserted to the fixation holes 26 so as to fix the shaft sleeve 20 to the toilet 002.

Preferred, the luminous unit 40 further comprises at least one photosensor 44, the front light source 41 and the rear light source startup to provide light if the photosensor 44 collects no light. in other case, the luminous unit 40 further comprises a sound collecting component 45 and at least one photosensor 44, the sound collecting component 45 startups if the photosensor 44 collects no light, the front light source and the rear light source 42 startup to provide light if the sound collecting component 45 receives sound signal. In other case, the luminous unit 40 further comprises a sound collecting component 45 and two photosensors 44, two photosensors 44 are respectively used to collect the light at the front side and the rear side of the shaft sleeve, the sound collecting component 45 startups if the photosensors 44 collect no light, the front light source and the rear light source 42 startup to provide light if the sound collecting component 45 receives sound signal.

Preferred, the front light source 41, the sound collecting component 45 and one photosensor 44 are disposed in the front baseboard 46, the rear light source 42 and the other photosensor 44 are disposed in the rear baseboard 47.

Preferred, the battery module 43 comprises battery and battery compartment 432, the battery is placed in the battery compartment 432, the front baseboard 46 and the rear baseboard 47 are disposed on the outer side of the battery compartment 432, and are respectively connected at the front side and the rear side of the battery compartment 432.

Although the utility model has been described with reference to the preferred embodiments thereof for carrying out the patent for utility model, it is apparent to those skilled in the art that a variety of modifications and changes may be made without departing from the scope of the patent for utility model which is intended to be defined by the appended claims.

1. A luminous rotating shaft of toilet seat cover, comprising:
a shaft sleeve with two ends that the toilet seat cover is rotatably pivot joint to;
a luminous unit comprising a front light source, a rear light source and a battery module to supply power to the front light source and the rear light source;
the luminous unit is detachably assembled in the shaft sleeve, the shaft sleeve is disposed with a front window corresponding to the front light source, the front light source provides light to the toilet through the front window, the shaft sleeve is disposed with a rear window corresponding to the rear light source, the rear light source provides light to the toilet water tank or the wall through the rear window, the luminous unit further comprises two photosensors that are used to collect light at the front side and at the rear side of the shaft sleeve, the front light source and the rear light source startup to provide light if two photosensors collect no light at the same time.

2. The luminous rotating shaft of toilet seat cover according to claim 1, wherein the luminous unit further comprises a sound collecting component, two photosensors are arranged respectively corresponding to the front window and the rear window; the sound collecting component startups if two photosensors collect no light at the same time; the front light source and the rear light source startup to provide light if the sound collecting component receives sound signal.

3. The luminous rotating shaft of toilet seat cover according to claim 2, wherein the luminous unit further comprises a front baseboard and a rear baseboard, the front light source, the sound collecting component and one of the photosensors are disposed in the front baseboard, the rear light source and the other photosensor are disposed in the rear baseboard.

4. The luminous rotating shaft of toilet seat cover according to claim 3, wherein the battery module comprises battery and battery compartment, the battery is placed in the battery compartment, the front baseboard and the rear baseboard are respectively connected to the front side and the rear side of the battery compartment.

5. The luminous rotating shaft of toilet seat cover according to claim 4, wherein the luminous unit further comprises a cover and a transparent window, the cover is locked to the battery compartment, the cover is disposed with an opening, the transparent window covers the opening.

6. The luminous rotating shaft of toilet seat cover according to claim 1, wherein comprising a flexible elastic lock rod connected to the luminous unit and locked to the shaft sleeve.

7. The luminous rotating shaft of toilet seat cover according to claim 6, wherein the elastic lock roc comprising an elastic wire and two pins respectively connected to two ends of the elastic wire.

8. A luminous rotating shaft of toilet seat cover, comprising a shaft sleeve with two ends that the toilet seat cover is rotatably pivot joint to, wherein further comprising a front light source, a rear light source and two photosensors, the two photosensors are used to collect the light at the front side and rear side of the shaft sleeve, the front light source and the rear light source startup to provide light if two photosensors collect no light at the same time, the front light source provides light to the toilet, the rear light source provides light to the toilet water tank or the wall.

9. The luminous rotating shaft of toilet seat cover according to claim 8, wherein further comprising a sound collecting component, the sound collecting component startups if two photosensors collect no light at the same time; the front light source and the rear light source startup to provide light if the sound collecting component receives sound signal.

10. The luminous rotating shaft of toilet seat cover according to claim 9, wherein the sound collecting component is disposed in the shaft sleeve.

11. The luminous rotating shaft of toilet seat cover according to claim 10, wherein the shaft sleeve is disposed with a front window corresponding to the front light source, the front light source provides light to the toilet through the front window, the shaft sleeve is disposed with a rear window corresponding to the rear light source, the rear light source provides light to the toilet water tank or wall through the rear window.

12. The luminous rotating shaft of toilet seat cover according to claim 11, wherein further comprising a front baseboard and a rear baseboard, the front light source, the sound collecting component and one of the photosensors are disposed in the front baseboard, the rear light source and the other photosensor are disposed in the rear baseboard.

13. A luminous rotating shaft of toilet seat cover, comprising a shaft sleeve with two ends that the toilet seat cover is rotatably pivot joint to, wherein further comprising a luminous unit disposed with a front light source, a rear light source, a battery module, a front baseboard, a rear baseboard, the front light source is disposed in the front baseboard, the rear light source is disposed in the rear baseboard, the battery module provides power to the front light source and the rear light source, the luminous unit is detachably assembled in the shaft sleeve, the front light source provides light the toilet, the rear light source provides light to the toilet water tank or the wall.

14. The luminous rotating shaft of toilet seat cover according to claim 13, wherein the shaft sleeve is disposed with two fixation holes, two support shafts on the toilet are disposed to respectively insert to the two fixation holes to secure the shaft sleeve to the toilet.

15. The luminous rotating shaft of toilet seat cover according to claim 13, wherein the luminous unit further comprising at least one photosensor, the front source and the rear source startup to provide light if the photosensor collects no light.

16. The luminous rotating shaft of toilet seat cover according to claim 13, wherein the luminous unit further comprises a sound collecting component and at least one photosensor, the sound collecting component startups if the photosensor collects no light, the front light source and the rear light source startup to provide light if the sound collecting component receives sound signal.

17. The luminous rotating shaft of toilet seat cover according to claim 13, wherein the luminous unit further comprises a sound collecting component and two photosensors, two photosensors are respectively used to collect the light at the front side and the rear side of the shaft sleeve, the sound collecting component startups if two photosensors collect no light at the same time; the front light source and the rear light source startup to provide light if the sound collecting component receives sound signal.

18. The luminous rotating shaft of toilet seat cover according to claim 17, wherein the front light source, the sound collecting component and one of the photosensors are disposed in the front baseboard, the rear light source and the other photosensor are disposed in the rear baseboard.

19. The luminous rotating shaft of toilet seat cover according to claim 13, wherein the battery module comprises battery and battery compartment, the battery is placed in the battery compartment, the front baseboard and the rear baseboard are disposed and connected to the front side and the rear side of the battery compartment.
